(19) United States
(12) Patent Application Publication
(10) Pub. No.: US 2014/0002685 A1
(43) Pub. Date: Jan. 2, 2014

(54) PHASE FILTER AND IMAGING CAMERA SYSTEM USING THE SAME

(71) Applicant: HITACHI, LTD., Tokyo (JP)

(72) Inventor: Takeshi SHIMANO, Moriya (JP)

(21) Appl. No.: 13/860,566

(22) Filed: Apr. 11, 2013

(30) Foreign Application Priority Data
Apr. 17, 2012 (JP) 2012-093487

(51) Int. Cl. H04N 5/225

(52) U.S. Cl. CPC H04N 5/225
USPC 348/222.1; 348/360

(57) ABSTRACT

In an imaging camera system formed of a camera optical system that focuses an object to be imaged on an image sensor surface and a system that performs image processing on a detected image, a phase filter inserted in a position in the vicinity of an aperture of the optical system is characterized in that the phase filter has at least one surface having a non-rotationally symmetrical aspheric shape having three protrusion and three recesses within an effective diameter, one of the protrusions having a local maximum within the effective diameter, one of the recesses having a local minimum within the effective diameter, the remaining two protrusions and recesses continuously inclined toward a region outside the effective diameter.

### INCORPORATION BY REFERENCE

The present application claims priority from Japanese application JP2012-093487 filed on Apr. 17, 2012, the content of which is hereby incorporated by reference into this application.

### BACKGROUND OF THE INVENTION

The present invention relates to a phase filter that increases the depth of field and the depth of focus of an imaging camera system, and an imaging camera system using the phase filter.

As related art of the present technical field, JP-A-2002-513951 (Patent Literature 1) is disclosed. In JP-A-2002-513951, a system for increasing the depth of field and decreasing the wavelength dependence of an incoherent optical system incorporates a specific purpose optical mask into the incoherent optical system. The optical mask has been designed to cause the optical transfer function thereof to remain essentially constant within some range from the in-focus position. Signal processing of the resulting intermediate image undoes the optical transfer modifying effects of the mask, resulting in an in-focus image over an increased depth of field. Generally, the mask is placed at or near an aperture stop or an image of the aperture stop of the optical system. Preferably, the mask modifies only phase and not amplitude of light, though amplitude may be changed by associated filters or the like. Patent Literature 1 describes that the mask may be used to increase the useful range of passive ranging systems (see Abstract).

### SUMMARY OF THE INVENTION

A phase filter used in the related described above has a special aspheric shape, and plastic injection molding is currently widely used to create such an aspheric shape. A die used in plastic injection molding is formed by using an aspheric surface forming apparatus equipped with a numerical control mechanism to machine a metal plate with a diamond cutting tool. A phase filter can be formed by injecting a plastic material melted at a high temperature into the die formed as described above and allowing it to harden. In this process, larger protrusions and recesses of the aspheric shape result in a longer period necessary to machine the die, a higher material cost, operational power consumption, and other costs, a larger amount of waste, and a greater load on the environment. It is therefore required to design a shape having smaller protrusions and recesses. Further, a molded component having larger protrusions and recesses disadvantageously results in a larger thickness thereof and a greater size and weight of an optical system into which the component is inserted.

To solve the problems described above, for example, the configurations set forth in the claims are employed.

The present application encompasses a plurality of means for solving the problems described above, and an example thereof is as follows: In an imaging camera system including a camera optical system that focuses an object to be imaged on an image sensor surface and a system that performs image processing on a detected image, a phase filter inserted in a position in the vicinity of an aperture of the optical system is characterized in that the phase filter has at least one surface having a non-rotationally symmetrical aspheric shape having three protrusion and three recesses within an effective diameter, one of the protrusions having a local maximum within the effective diameter, one of the recesses having a local minimum within the effective diameter, the remaining two protrusions and recesses continuously inclined toward a region outside the effective diameter. Another example is an imaging camera system using the phase filter.

The protrusions and recesses of the aspheric surface of the phase filter for increasing the depth of focus are halved. The period required to machine a die is halved. The material cost, operational power consumption, and other costs can be reduced. The amount of waste can be reduced. The load on the environment can be reduced. Further, the thickness of the phase filter can be reduced, and the size and weight of an optical system into which the phase filter is inserted can be reduced.

### BRIEF DESCRIPTION OF THE DRAWINGS

FIG. 1 shows an embodiment of a phase filter according to the present invention;

FIG. 2 is a schematic configuration diagram of an imaging system using the phase filter according to the present invention;

FIG. 3 shows a phase filter of related art that provides the same effect as that provided by the phase filter according to an embodiment of the present invention;

FIG. 4 shows results of a simulation for checking an effect of increasing the depth of focus achieved by the phase filter according to the present invention.

### DETAILED DESCRIPTION OF THE INVENTION

Embodiment will be described below with reference to the drawings.

### [First Embodiment]

Here, an embodiment of a phase filter according to the present invention will be described.

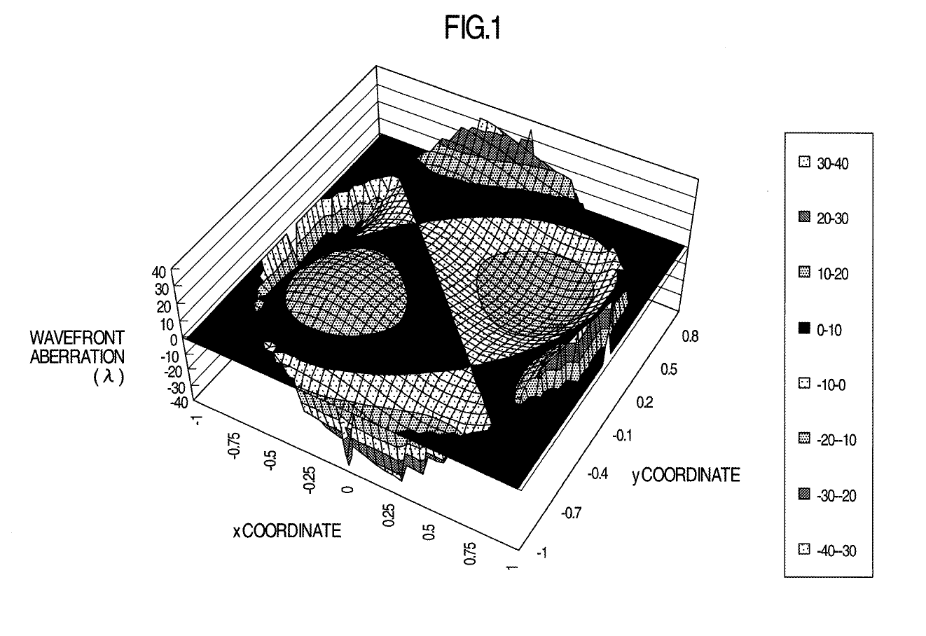

FIG. 1 is a perspective view of a wavefront aberration produced by the phase filter according to the present embodiment. The surface shape of the phase filter is assumed to be expressed by z=f(x,y), which is a function of pupil plane normalized coordinates x and y that are values normalized by the pupil radius in the filter plane, and z represents the optical axis direction or a z axis. The wavefront aberration is then expressed by w(x,y)=(n−1)×f(x,y), where n represents the refractive index of the optical material that forms the filter. The perspective view therefore shows a shape directly reflecting the surface shape. In the present embodiment, when the shape is expressed by f(x,y)=α{x³+y³−(x+y)/2}, α=69λ (λ: central wavelength of light involved in focusing). The wavefront aberration can also be expressed in the form of a Zernike polynomial as follows:

$$z ( ρ ) = {A}_{7} ( 3 {ρ}^{3} - 2 ρ ) cos θ + {A}_{8} ( 3 {ρ}^{3} - 2 ρ ) sin θ + {A}_{10} {ρ}^{3} cos 3 θ + {A}_{11} {ρ}^{3} sin 3 θ \\ ρ = \sqrt{{x}^{2} + {y}^{2}} \\ tan θ = \frac{y}{x} \\ {A}_{7} = {A}_{8} = {A}_{10} = \frac{17.25 λ}{n - 1} \\ {A}_{11} = - \frac{17.25 λ}{n - 1} \qquad [ expression 1 ]$$

The peak-to-peak value of the wavefront aberration is about 80λ, as shown in FIG. 1. The shape factor a of the phase filter according to the present embodiment is designed in accordance with an actual example of a focusing optical system that will be described later and optimized in accordance with the optical system. A general shape of the phase filter has three protrusions and three recesses within a circular effective diameter, one of the protrusions having a local maximum within the effective diameter and one of the recesses having a local minimum within the effective diameter. The remaining two protrusions and recesses are continuously inclined toward a region outside the effective diameter. In the formation of a plate-shaped filter, a flat rear surface is formed in substantially parallel to the xy plane. The thus shaped filter is convenient for evaluation of the aspheric shape of the surface with reference to the rear surface by using a stylus-type shape measuring device.

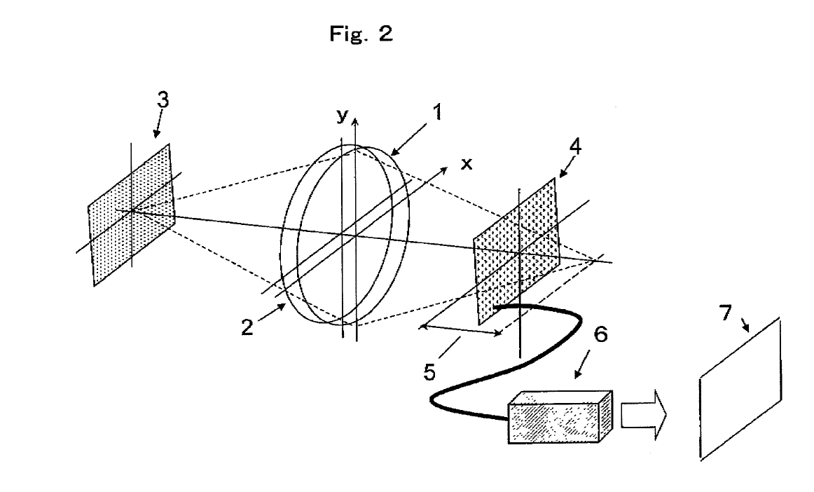

FIG. 2 is a schematic configuration diagram of an imaging system using the phase filter according to the present embodiment. The imaging system includes a camera optical system formed as appropriate of a phase filter 1 and a focusing lens 2, a sensor 4, and an image processor 6. The phase filter 1 is disposed in the aperture position of the focusing lens 2. After an input image of an object plane 3 to be focused is focused on a sensor surface of the sensor 4 and detected by the sensor 4, the image processor 6 performs imaging processing on the image having any misfocus 5 to form a misfocus-free output image 7.

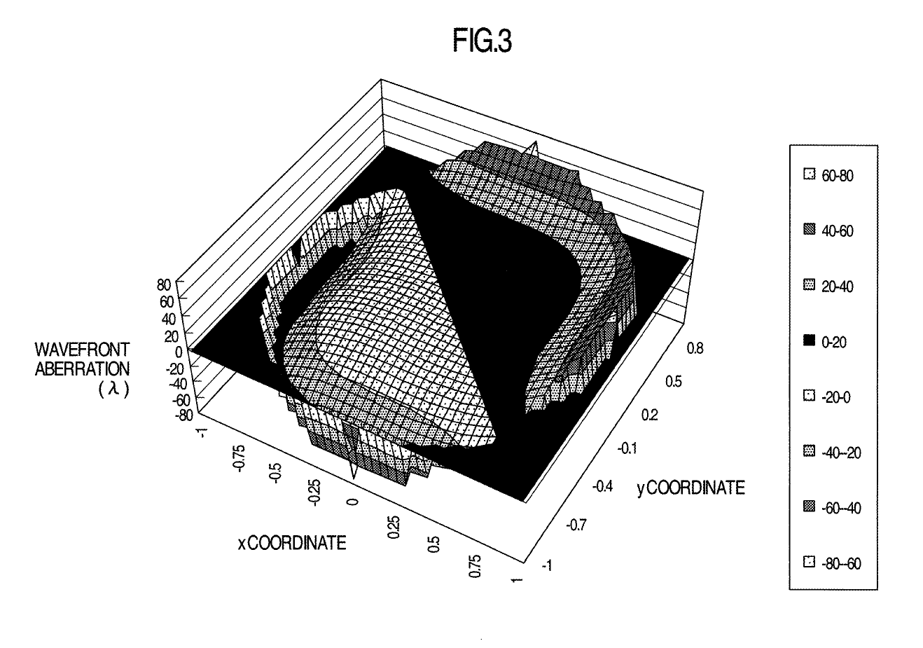

FIG. 3 shows a phase filter of related art that provides the same effect of increasing the depth of focus as the effect provided by the phase filter according to the present embodiment shown in FIG. 1 for comparison purposes. When the shape of the phase filter is assumed to be expressed by f(x,y)=α(x³+y³), α=69λ. The peak-to-peak value of the wavefront aberration is about 160λ, as shown in FIG. 3. The value is twice the size of the protrusions and recesses of the phase filter according to the present embodiment shown in FIG. 1, indicating that the phase filter according to the present embodiment can halve the size of protrusions and recesses as compared with the size in the related art.

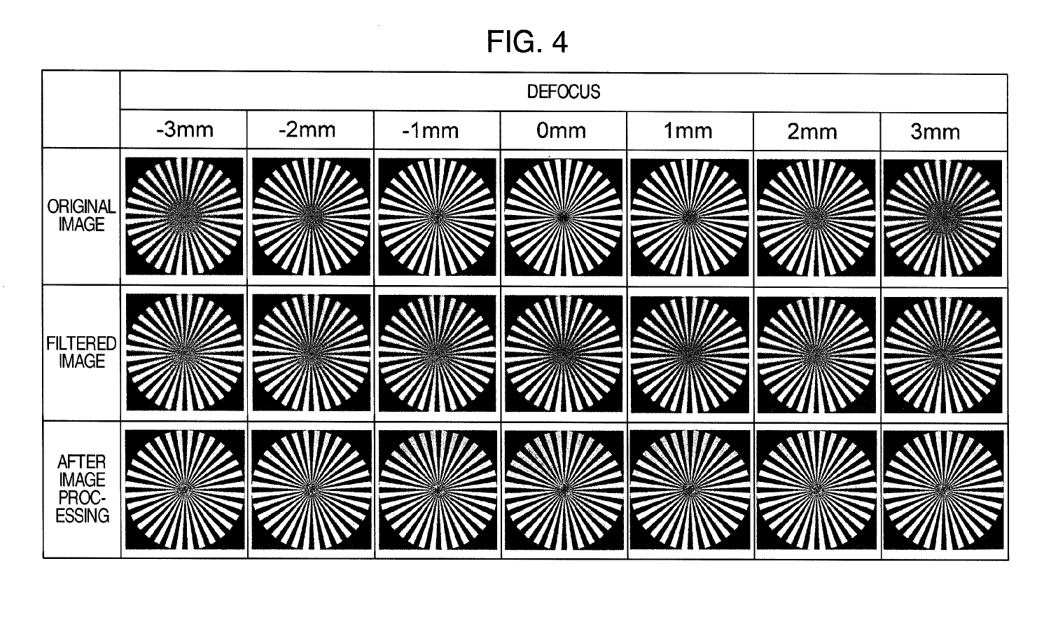

FIG. 4 shows results of a simulation of the effect of increasing the depth of focus achieved by using the phase filter shown in FIG. 1. A spoke-shaped test chart is used as an input image, and detected images obtained by changing the amount of misfocus (defocus) on the sensor surface produced by a focusing lens that focuses the test chart are arranged horizontally. The upper part shows detected images produced by a typical optical system. The middle part shows detected images produced when the phase filter according to the present invention is disposed at the aperture plane. The lower part shows the middle-part images having undergone image processing. It is assumed that the focusing lens has a focal length of 50 mm, an aperture diameter of 12.5 mm, and an f-number of 4; the sensor size is 22.5 mm square; the wavelength is 0.5 μm; the object distance is 50 cm; the image distance is 55.56 mm; the object size is 202.5 mm; and the maximum angle of view is 11.4°. The simulation substantially follows the procedure described in Patent Literature 1: A spatial frequency transfer function (OTF) of the optical system is determined by Fourier-transforming a point image intensity distribution resulting from the defocus and the wavefront aberration of the phase filter, and a Fourier transformed input image is multiplied by the OTF, followed by inverse Fourier transformation to determine a detected image. To determine a reproduced image, what is called deconvolution, in which a Fourier transformed detected image is multiplied by the reciprocal of the transfer function of the phase filter, followed by inverse Fourier transformation, is performed. The same transfer function to be multiplied in the deconvolution is used over the range of defocus position. In this case, the image-side NA is 0.1125, and the depth of focus is 39.5 μm. In the detected images produced by the optical system of related art, the image blur produced at a central portion where the spatial frequency is high proceeds toward the periphery as the amount of misfocus increases, whereas in the detected images produced with the filter inserted, the images are uniformly blurred over the misfocus range. The lower part shows that the image processing produces substantially blur-free detected images similar to each other over the range of misfocus position. If a depth of focus of 6 mm is achieved, it is shown that the depth of focus is increased to a value 151 times a theoretical depth of focus.

It should be further understood by those skilled in the art that although the foregoing description has been made on embodiments of the invention, the invention is not limited thereto and various changes and modifications may be made without departing from the spirit of the invention and the scope of the appended claims.

1. A phase filter used in a camera optical system, wherein at least one surface of the phase filter has a non-rotationally symmetrical aspheric shape having three protrusions and three recesses within an effective diameter, one of the three protrusions having a local maximum within the effective diameter, one of the three recesses having a local minimum within the effective diameter, and the other two of the three protrusions and the other two of the three recesses inclined toward a region outside the effective diameter.

2. The phase filter according to claim 1, wherein
the other surface of the phase filter is a flat surface, and
the aspheric shape of the one surface is based on a value calculated with reference to the other flat surface.

3. The phase filter according to claim 1, wherein
the phase filter produces a wavefront aberration expressed by f(x,y)=α{x³+y³−(x+y)/2} (where x and y represent normalized coordinates that are perpendicular to an optical axis and present in a phase filter plane).

4. An imaging camera system comprising:
a sensor;
a camera optical system that focuses an object to be imaged on a surface of the sensor; and
an image processor that performs image processing on a detected image detected by the sensor,
wherein the camera optical system includes the phase filter according to claim 1.

5. An imaging camera system comprising:
a sensor;
a camera optical system that focuses an object to be imaged on a surface of the sensor; and
an image processor that performs image processing on a detected image detected by the sensor,
wherein the camera optical system includes the phase filter according to claim 2.

6. An imaging camera system comprising:
a sensor;
a camera optical system that focuses an object to be imaged on a surface of the sensor; and
an image processor that performs image processing on a detected image detected by the sensor,
wherein the camera optical system includes the phase filter according to claim 3.
